(19) United States
(12) Patent Application Publication
(10) Pub. No.: US 2011/0253406 A1
(43) Pub. Date: Oct. 20, 2011

(54) PORTABLE POWER TOOL BATTERY

(76) Inventor: Rainer GLAUNING, Leinfelden-Echterdingen (DE)

(21) Appl. No.: 13/089,706

(22) Filed: Apr. 19, 2011

(30) Foreign Application Priority Data
Apr. 20, 2010 (DE) 102010027974.9

(51) Int. Cl. B25F 5/00; H01H 85/54; H01M 2/02

(52) U.S. Cl. 173/217; 429/163; 337/214

(57) ABSTRACT

A portable power tool battery has at least one fuse holder. The fuse holder is provided for detachably attaching a fuse situated in the fuse holder in a form-fitting and/or force-locking manner.

### BACKGROUND INFORMATION

A portable power tool battery having at least one fuse holder has already been provided.

### SUMMARY OF THE INVENTION

The present invention is directed to a portable power tool battery having at least one fuse holder.

It is provided that the fuse holder be provided for detachably attaching a fuse situated in the fuse holder in a form-fitting and/or force-locking manner. A “fuse holder” should be understood here in particular to be a device which mechanically secures a fuse in a ready-to-operate state and advantageously connects it to another area of the portable power tool battery. The fuse holder is preferably provided to contact the fuse in a thermally conducting and/or advantageously in an electrically conducting manner. In particular the term “provided” should be interpreted specifically and/or understood as being designed or equipped. A “fuse” should be understood in particular to be a unit which prevents operation during and advantageously after an inadmissible operating state, in particular preventing operation of a portable power tool battery connected to the fuse. In a ready-to-operate state, preferably at least one characteristic having at least one item of information about a current operating state is acting on the fuse. The fuse is advantageously designed to be a disposable fuse, i.e., the fuse must be replaced after being deployed due to an inadmissible operating state. The term “form-fitting” should be understood in particular to mean that the fuse holder attaches the fuse in a ready-to-operate state by spatial expansion, which counteracts movement of the fuse. The term “force-locking” should be understood in particular to mean that the fuse holder secures the fuse in a ready-to-operate state by a force acting steadily and in particular by friction caused by the force. The fuse and the fuse holder are preferably not materially bonded. The term “detachably attached” in particular should be understood to mean that the fuse may be removed from the fuse holder in a nondestructive manner and in particular may be removed only with reversible deformation of the material of the fuse holder. The portable power tool battery is preferably designed to be a replaceable portable power tool battery. Alternatively, the portable power tool battery may be provided for being connected to a portable power tool for its entire lifetime. Due to the design of the portable power tool battery according to the present invention, the fuse may be replaced with particularly little effort. Therefore less expensive fuses having a less precise deployment characteristic may be used. Damage and complexity for a customer are advantageously low in the event of deployment of the fuse.

In another embodiment, it is provided that the fuse holder be provided for replaceably attaching the fuse without a tool, so that for a customer, the effort caused by deployment of the fuse is particularly low. The phrase “replaceable without a tool” should be understood in particular to mean that the fuse holder has only fuse fastening means, which are operable by an operator by hand.

In addition, it is provided that the fuse holder be provided for attaching a temperature fuse and/or an electrical fuse, so that particularly advantageous protection of the portable power tool battery is achievable. A “temperature fuse” should be understood in particular to be a fuse which prevents operation for a period of time after a deployment temperature has been exceeded, in particular by an electronic device and/or advantageously by a battery. A “current protector” is understood in particular to be a fuse, which is removed from the battery, in particular after an operating current is exceeded, preventing operation for a period of time. The period of time is preferably ended by replacement of the fuse.

Furthermore, it is provided that the portable power tool battery shall have a battery casing having a fuse receptacle which surrounds a reachable exchange area of the fuse at least partially. A “fuse receptacle” should be understood in particular to be an area of the battery casing which delimits an opening and/or an indentation in an outer surface of the battery casing. “Reachable” should be understood in particular to mean that an operator is able to reach into the exchange area in at least one operating state. An “exchange area” should be understood in particular to be an area through which a fuse is movable out of the battery casing when replacing the fuse. The phrase “surrounded at least partially” in this context should be understood to mean that the fuse receptacle surrounds at least one point of the exchange area on a plane by more than 180 degrees, advantageously completely. The casing of the portable power tool battery advantageously need not be opened for replacing the fuse due to the fuse receptacle.

It is additionally provided that the battery casing shall have at least one fuse cover, which covers the exchange area in at least one operating state, so that the fuse holder and the fuse are advantageously protected from soiling in particular. The fuse cover could be connectable to the battery casing in a manner which seems appropriate to those skilled in the art, for example, by screw connection, snap connection, and/or advantageously lock connection.

In addition it is provided that the portable power tool battery shall have at least one lithium battery which supplies a portable power tool with electrical power during operation so that an advantageously protected and particularly efficient energy storage mechanism may be achieved. A “lithium battery” should be understood in particular to be a battery which makes available electrical power due to the displacement of lithium ions. Alternatively the portable power tool battery could also have another battery which appears reasonable to those skilled in the art and/or another accumulator. Due to the design according to the present invention, a lithium battery may be protected via simple design measures using a reliably deploying fuse without any great disadvantages for the operator.

It is additionally provided that the portable power tool battery shall have an interface which is provided for separably contacting a portable power tool. A casing of the portable power tool battery and a casing of the portable power tool are advantageously designed to be separate. Alternatively or additionally, the portable power tool battery could be permanently integrated into the portable power tool, i.e., in particular separable only by using a tool. A housing of the portable power tool battery and a housing of the portable power tool are designed at least partially in one piece. “Separable” in this context should be understood in particular to mean that the portable power tool battery is removable from the portable power tool by an operator in a nondestructive manner and advantageously without the use of tools. The portable power tool battery may advantageously be used separately and/or advantageously be charged by a portable power tool via the interface.

Furthermore, the present invention is directed to a system having a portable power tool and a portable power tool battery, so that all the portable power tools seeming reasonable to those skilled in the art such as, in particular, drills, drill hammers, saws, planes, screwdrivers, millers, grinders, angle grinders and/or multifunction tools for operation using a portable power tool battery according to the present invention are conceivable, whereby a portable power tool which may be used particularly safely may be made available.

### BRIEF DESCRIPTION OF THE DRAWINGS

FIG. 1 shows a portable power tool battery having a fuse holder according to the present invention in a perspective view.

FIG. 2 shows the fuse holder from FIG. 1 in a side view.

FIG. 3 shows the fuse holder from FIG. 1 in a front view.

FIG. 4 shows another exemplary embodiment of a fuse holder in a front view.

FIG. 5 shows a fuse in a side view belonging to the fuse holder from FIG. 4.

### DETAILED DESCRIPTION

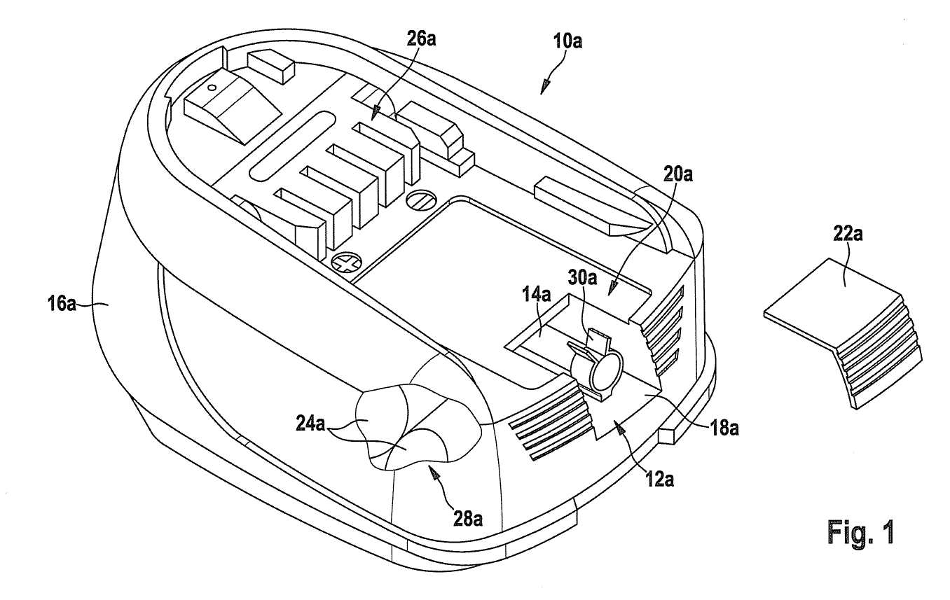

FIG. 1 shows a portable power tool battery 10a according to the present invention. Portable power tool battery 10a has a fuse holder 12a, a battery casing 16a, a battery pack 28a having a plurality of lithium batteries 24a and an interface 26a. Interface 26a contacts a portable power tool, which is not presented in greater detail here a drill, in an electrically conducting and mechanically stable manner in a ready-to-operate mode. A connection of interface 26a to the portable power tool is detachable by an operator without the use of tools. Battery pack 28a supplies electrical power to a portable power tool during operation. Battery casing 16a surrounds battery pack 28a completely. Battery casing 16a is shown in a breakaway diagram to illustrate battery pack 28a.

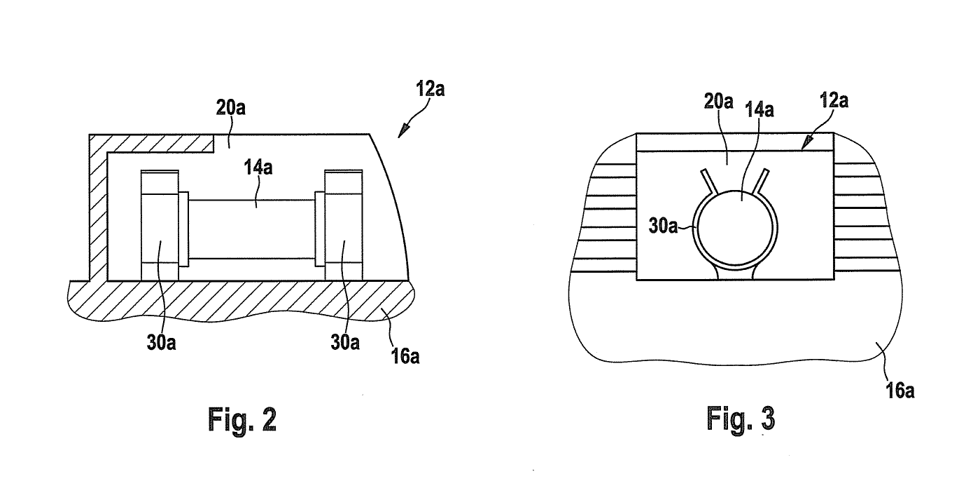

As FIGS. 2 and 3 show, fuse holder 12a detachably attaches a fuse 14a situated in fuse holder 12a in a form-fitting and force-locking manner. Fuse 14a is replaceable by an operator without tools. Fuse holder 12a has two spring means 30a for this purpose. Spring means 30a are situated at a distance from one another in the main direction of extent of fuse 14a. Spring means 30a each conductively surround a contact of fuse 14a. Spring means 30a apply a force to fuse 14a. Fuse 14a is designed to be an electrical fuse, namely to be a miniature fuse.

During operation, a large portion of the electrical power withdrawn from battery pack 28a flows through fuse 14a. When the power exceeds a nominal power of the fuse, the fuse is deployed and interrupts power withdrawal from battery pack 28a.

Battery casing 16a has a fuse receptacle 18a. Fuse receptacle 18a partially surrounds a reachable exchange area 20a of fuse 14a. Exchange area 20a is situated in a recess in an outer surface of battery casing 16a. Battery casing 16a has a fuse cover 22a. When installed, fuse cover 22a covers exchange area 20a. For this purpose, fuse cover 22a locks onto battery casing 16a. Fuse 14a may be replaced in this way without having to open battery casing 16a except for fuse cover 22a.

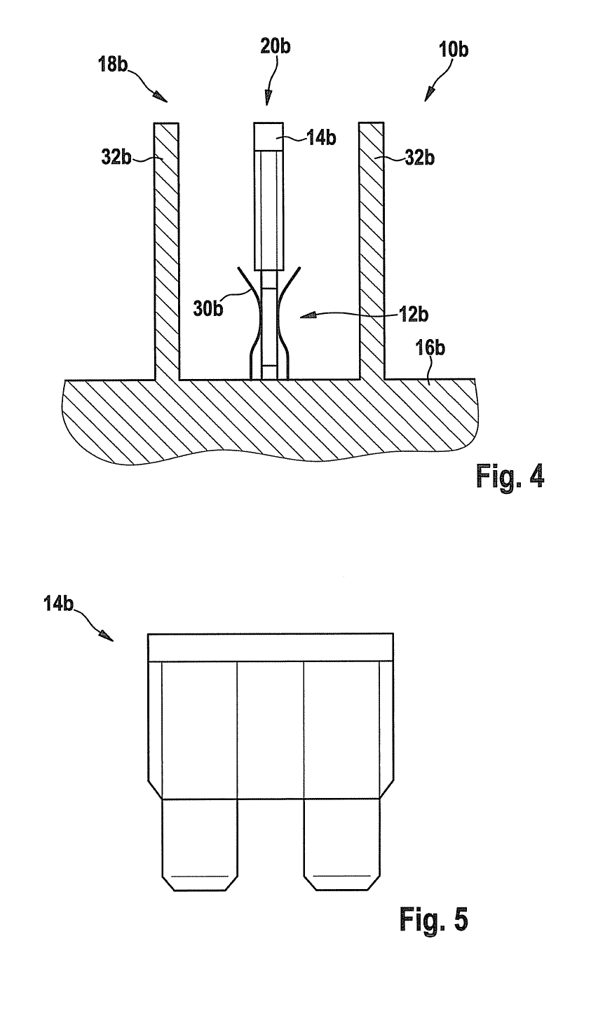

FIGS. 4 and 5 illustrate another exemplary embodiment of the present invention. The following descriptions and drawings are limited essentially to the differences between the exemplary embodiments, but reference is made essentially to the drawings and/or the description of the other exemplary embodiments, in particular FIGS. 1 through 3 with respect to components identified in the same way, in particular with respect to components having the same reference numerals. For differentiating the exemplary embodiments, the letter a follows the reference numeral of the exemplary embodiments in FIGS. 1 through 3. In the exemplary embodiment of FIGS. 4 and 5, the letter a is replaced by the letter b.

FIGS. 4 and 5 show an alternative design of a fuse holder 12b of a portable power tool battery 10b according to the present invention in another exemplary embodiment. Fuse holder 12b attaches a fuse 14b situated in fuse holder 12b in a force-locking and detachable manner, namely exchangeable without tools. For this purpose, fuse holder 12b has two spring means 30b. Spring means 30b are situated at a distance from one another in the main direction of extent of fuse 14b. Spring means 30b each exert a spring force on a conducting contact of fuse 14b. Fuse 14b is designed to be an electrical fuse, namely to be a flat fuse. Two integrally molded shapes 32b on a battery casing 16b of portable power tool battery 10b protect fuse 14b from mechanical loads.

What is claimed is:

1. A portable power tool battery comprising:
at least one fuse holder for detachably attaching a fuse, situated in the fuse holder, in at least one of a form-fitting manner and a force-locking manner.

2. The portable power tool battery according to claim 1, wherein the fuse holder is for replaceably attaching the fuse without tools.

3. The portable power tool battery according to claim 1, wherein the fuse holder is for attaching at least one of a temperature fuse and an electrical fuse.

4. The portable power tool battery according to claim 1, further comprising a battery casing having a fuse receptacle, which at least partially surrounds a reachable exchange area of the fuse.

5. The portable power tool battery according to claim 4, wherein the battery casing has at least one fuse cover, which covers the exchange area in at least one operating state.

6. The portable power tool battery according to claim 1, further comprising at least one lithium battery, which supplies electrical power to a portable power tool in operation.

7. The portable power tool battery according to claim 1, further comprising an interface for separably contacting a portable power tool.

8. A system comprising:
a portable power tool; and
a portable power tool battery including at least one fuse holder for detachably attaching a fuse, situated in the fuse holder, in at least one of a form-fitting manner and a force-locking manner.
